(19) United States
(12) Patent Application Publication
(10) Pub. No.: US 2011/0239955 A1
(43) Pub. Date: Oct. 6, 2011

(54) Pet paw cleaning device

(76) Inventor: Charla Miller, Grand Island, NE (US)

(21) Appl. No.: 12/798,381

(22) Filed: Apr. 2, 2010

(51) Int. Cl. A01K 13/00

(52) U.S. Cl. 119/673

(57) ABSTRACT

A two-piece pet paw cleaning device is provided which is comprised of first and second identical tray members which may be connected together to form a spill-resistant container but which may be separated from one another so that one of the tray members may be used to clean a paw of a pet with the other tray member being used to dry the clean paw of the pet.

### BACKGROUND OF THE INVENTION

1. Field of the Invention

This invention relates to a device for cleaning the paws of a pet such as a dog or the like when the dog is brought inside from the outdoors. Even more particularly, the instant invention relates to a dog paw cleaning device which is comprised of two identical tray members which may be selectively secured together for storage and/or transport. Even more particularly, the instant invention relates to a two-piece dog paw cleaning device wherein a paw of the dog may be placed into the first tray member which contains water so that the paw may be cleaned with the paw of the dog then being placed into the second tray member which includes a towel positioned therein to dry the paw of the dog.

2. Description of the Related Art

When pet owners, such as dog owners, bring their dog indoors from the outside, it is necessary to clean the paws of the dog of mud, snow, water, etc. to prevent the dog from tracking the same into the house or RV. In some cases, the dog owner attempts to clean the paws of the dog with a towel, either wet or dry. It is difficult to clean the paws of the dog due to the fact that debris is often located between the pads of the dog's paw. Further, if the dog owner attempts to clean the paws of the dog by placing the paw or paws of the dog into a pan of water, water is sometimes splashed from the pan. Additionally, even if the dog owner is successful in cleaning the paws of the dog in a pan of water, it is difficult to dry the paws of the dog. An additional problem in using a pan filled with water is that the pan is not easily transported from one location to another. Many elaborate pet cleaners or washers have been previously provided but they suffer from certain disadvantages. First, they may be quite expensive. Second, they may be very large making the same difficult to store, move or transport.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A device is disclosed for cleaning and drying the paws of a pet such as a dog or the like. In a first embodiment of the invention, the device comprises identical first and second tray members. The first tray member includes a bottom wall having first and second end walls and first and second side walls extending upwardly therefrom and which have upper edges with the end and side walls having inner and outer surfaces. A first latch member extends upwardly from the first end wall of the first tray member and a second latch member is positioned on the outer side of the second end wall of the first tray member. The second tray member includes a bottom wall having first and second end walls and first and second side walls extending upwardly therefrom which have upper edges with the end and side walls having inner and outer sides. A first latch member extends upwardly from the first end wall of the second tray member and a second latch member is positioned on the outer side of the second end wall of the second tray member. The first and second tray members are identical so as to be interchangeable with one another.

The first and second tray members are normally disconnected from one another in use so that the first tray member may have water placed therein for cleaning the paw of the pet when the paw is placed therein and so that the clean paw, after being removed from the first tray member, may be placed in the second tray member for drying. The second tray member is positionable on the first tray member, when inverted and rotated 180°, so that the first latch member of the second tray member may be latched to the second latch member of the first tray member and so that the first latch member of the first tray member may be latched to the second latch member of the second tray member to secure the first and second tray members together in a closed spill-resistant manner.

In the first embodiment, the bottom walls of the first and second tray members have a plurality of spaced-apart projections extending upwardly therefrom with the projections being hollow with a closed upper end. In the first embodiment, the device further includes a drying member such as a towel placed in the second tray member. In the first embodiment, the first and second tray members are comprised of a plastic material.

In a second embodiment of the invention, the first and second end walls and the first and second side walls extend upwardly and outwardly from the bottom wall so that the first and second tray members may be positioned in a nested relationship with respect to one another for shipping, storage and transport thereof. In the second embodiment, the first and second tray members are secured together in a different manner than in the first embodiment.

It is therefore a principal object of the invention to provide an improved device for cleaning the paws of a pet such as a dog or the like.

A further object of the invention is to provide a device of the type described which is comprised of identical first and second tray members which may be connected together to form a spill-resistant container and which may be separated so that a paw of a pet may be first cleaned in the first tray member and then dried in the second tray member.

A further object of the invention is to provide a device for cleaning and drying the paws of a pet such as a dog or the like which is easy to use and which is transportable.

A further object of the invention is to provide a device of the type described which is durable in use, refined in appearance and economical of manufacture.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the device of this invention with the tray members being secured together to form a spill-resistant container or enclosure;

FIG. 2 is a sectional view of the device of this invention;

FIG. 3 is an upper perspective view of the first tray member;

FIG. 4 is a perspective view illustrating the first and second tray members being separated with the paw of a pet being placed in the first tray member to clean the same;

FIG. 5 is a perspective view of the modified first tray member of this invention;

FIG. 6 is a perspective view of the second tray member of the modified form of the invention with the second tray member being identical to the first tray member of FIG. 5;

FIG. 7 is a perspective view illustrating the first and second tray members of the second embodiment being secured together in a spill-resistant manner; and

FIG. 8 is a sectional view of the second embodiment with the first and second tray members being in a closed position.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

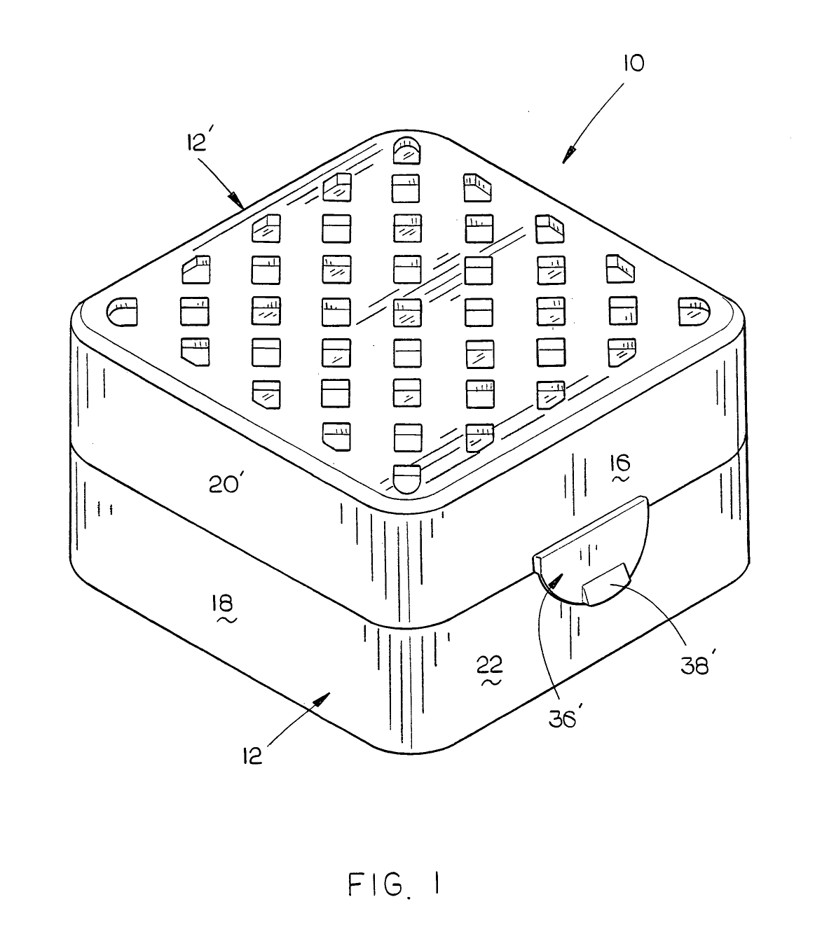

In the drawings, the numeral 10 refers to the device of this invention for cleaning and drying the paws of a pet such as a dog or the like. Device 10 includes identical tray members 12 and 12′ adapted to be selectively secured together as seen in FIG. 1 for storage and/or transport. Inasmuch as tray members 12 and 12′ are identical, only tray member 12 will be described in detail with “′” indicating identical structure on tray member 12′.

Tray member 12 includes a bottom wall 14 with walls 16, 18, 20 and 22 extending upwardly therefrom. Walls 16 and 22 of tray member 12 will be referred to as end walls while walls 18 and 20 will be referred to as side walls. Bottom wall 14 has a plurality of spaced-apart nubs or projections 24 extending upwardly therefrom which define channels or spaces 26 therebetween. Although it is preferred that the projections 24 have a square or cross section, the projections 24 could possibly take other shapes. The projections 24 are hollow and have closed upper ends.

A pair of horizontally spaced-apart guide rails 28 and 30 are integrally formed with end wall 16 at the inner surface thereof and have tapered upper ends 32 and 34 respectively. A latch member 36 is integrally formed with end wall 16 between rails 28 and 30 and is laterally outwardly offset from end wall 16. The upper inner side of latch member 36 has a tapered recess 38 formed therein above a horizontally extending latch bar 40 which protrudes inwardly therefrom. A pair of gussets 42 and 44 are provided at the ends of latch bar 40. The upper outer surface of end wall 22 has an outwardly projecting and horizontally extending latch bar 46 which has gussets 46 and 48 provided at the opposite ends thereof.

For purposes of description, the numeral 52 refers generally to the leg of the pet such as a dog or the like with the numeral 54 referring to a paw of the pet. The numeral 56 refers to a drying member such as a towel or the like which is placed within the tray member 12′ as will be described in more detail hereinafter. In the drawings, the numeral 58 refers to water or a cleaning solution which is placed in the tray member 12.

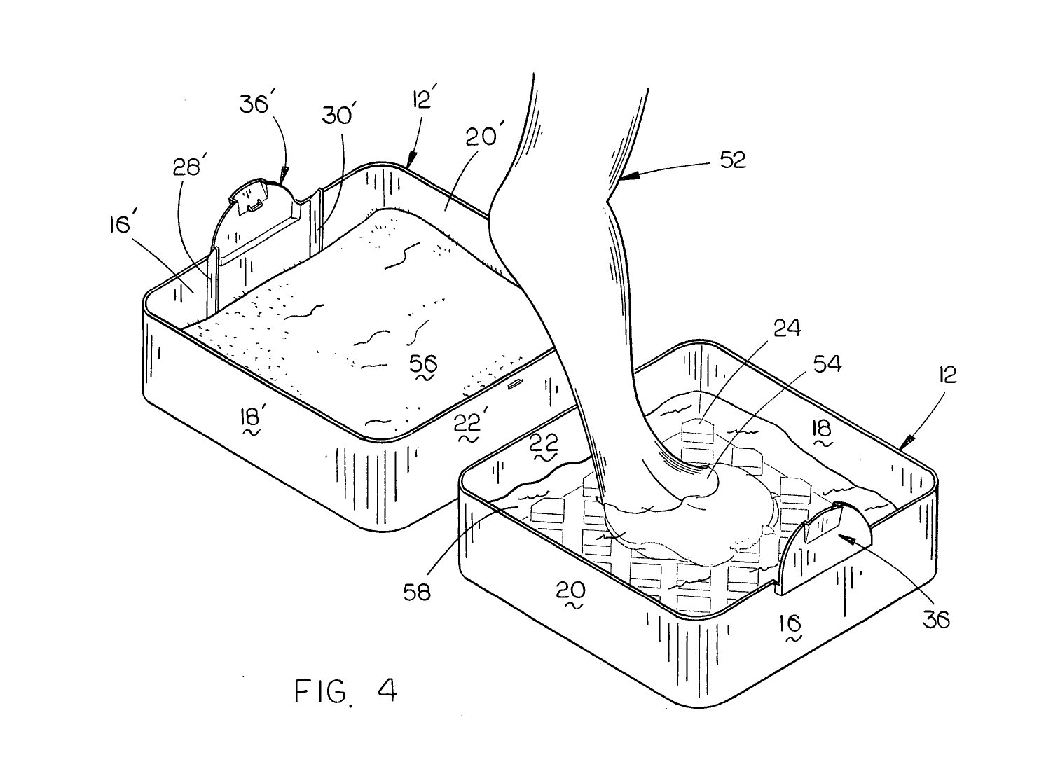

In use, the tray numbers 12 and 12′ will be disconnected from each other and placed on a supporting surface such as illustrated in FIG. 4. Water 58 is placed in the tray member 12 and preferably a towel 56 is placed in the tray member 12′. A paw of the pet is then placed in the tray member 12 with the upwardly extending projections 24 serving to separate the pads of the pet so that debris positioned between the pads of the paw 54 may be loosened and removed therefrom. The debris falling from the paw 54 will fall between the projections 24 so that the “clean” paw will not be in contact with debris. When the paw 54 has been cleaned, the leg of the pet is raised so that the paw 54 may then placed on the drying towel 56 in tray member 12. After the paw 54 has been dried with the towel 56, the other paws of the animal will be cleaned and dried as previously described.

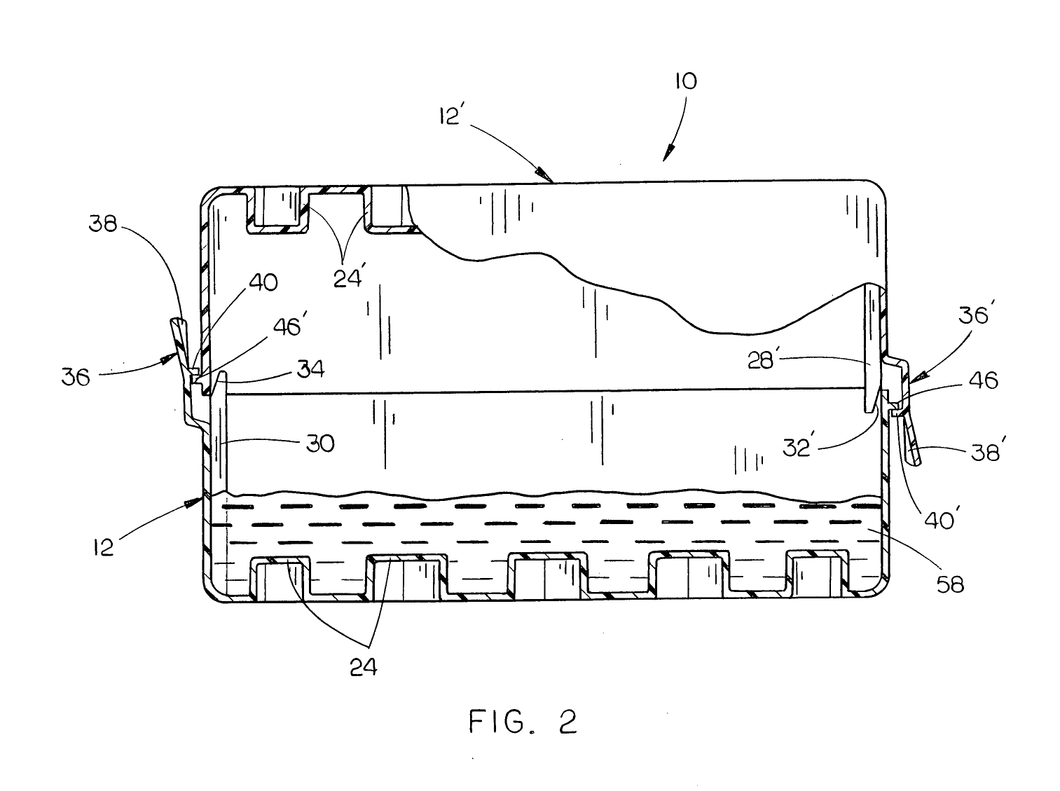

When it is desired to transport the device 10 from one location to another, or stored, tray member 12′ is inverted and rotated 180° from the position of FIG. 4 so that tray member 12′ rests on the upper edges of the walls of tray member 12 as seen in FIG. 2. Latch bar 40 of latch member 36 of tray member 12 is latched to the latch bar 46 as illustrated in FIG. 2 and the latch bar 40′ of tray member 12 is latched to the latch bar 46 of tray member 12 as also illustrated in FIG. 2.

During the connection process of tray member 12′ to the tray member 12, the tapered surfaces of the upper ends of the guide rails 28, 28′, 30 and 30′ serve to properly position the upper tray member 12′ with respect to the lower tray member 12. Inasmuch as the device 10 is spill-resistant when in the position of FIG. 2, there is no need for the water to be removed from the tray member 12.

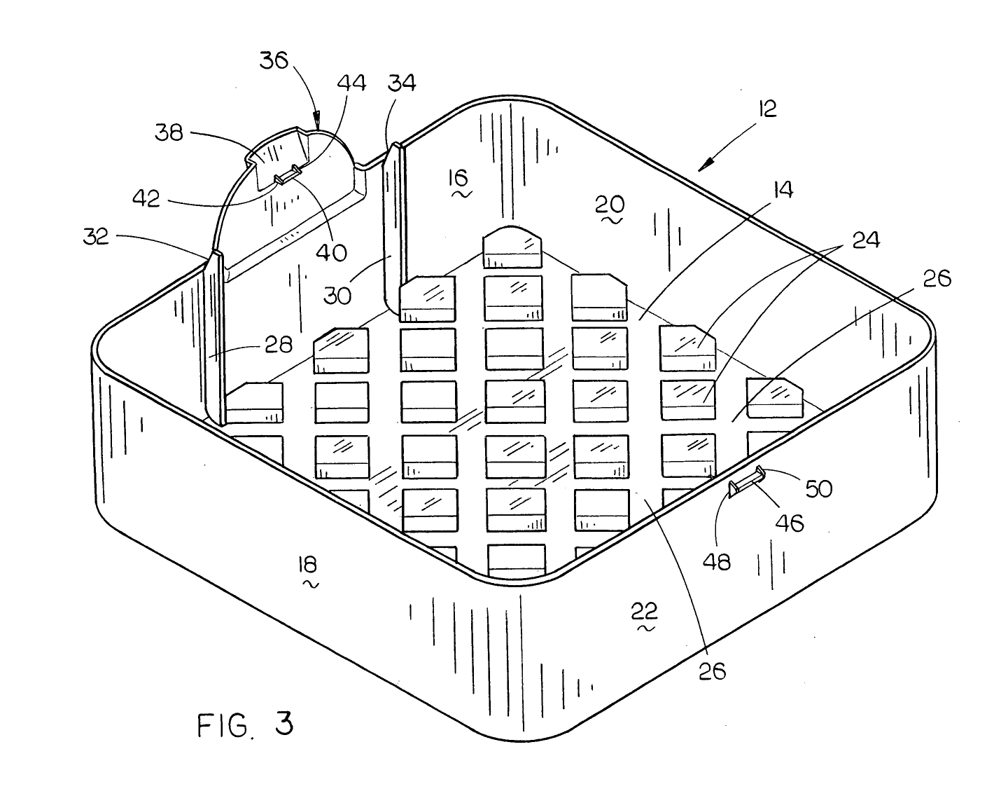

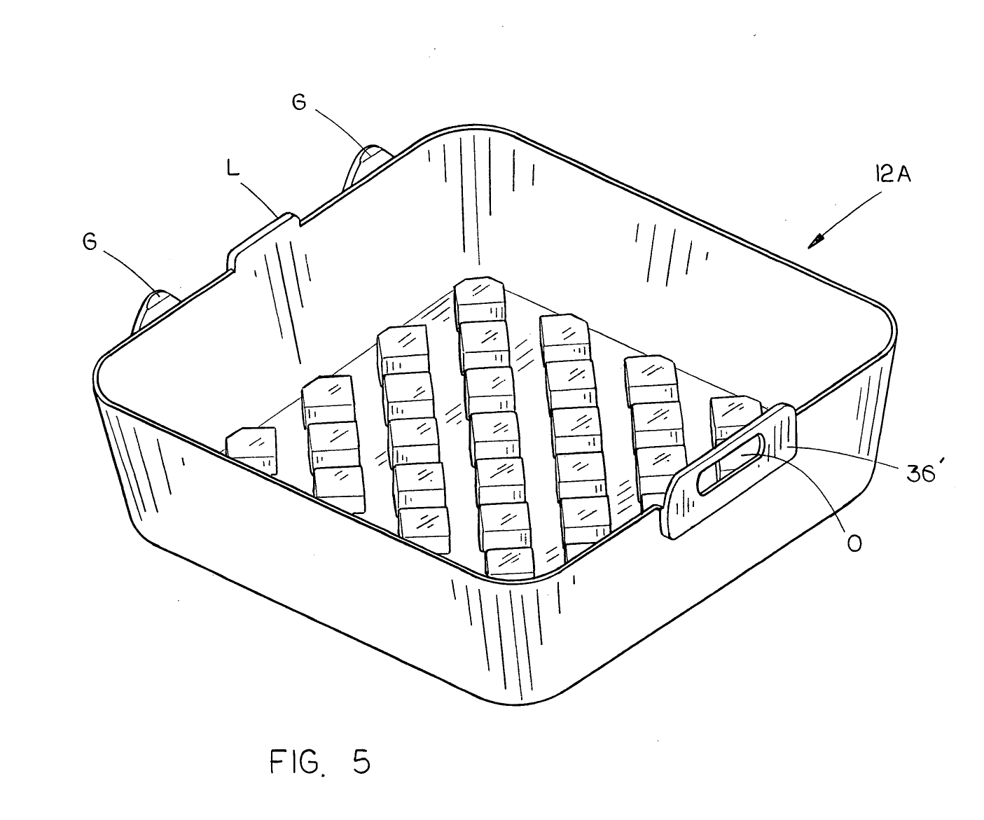

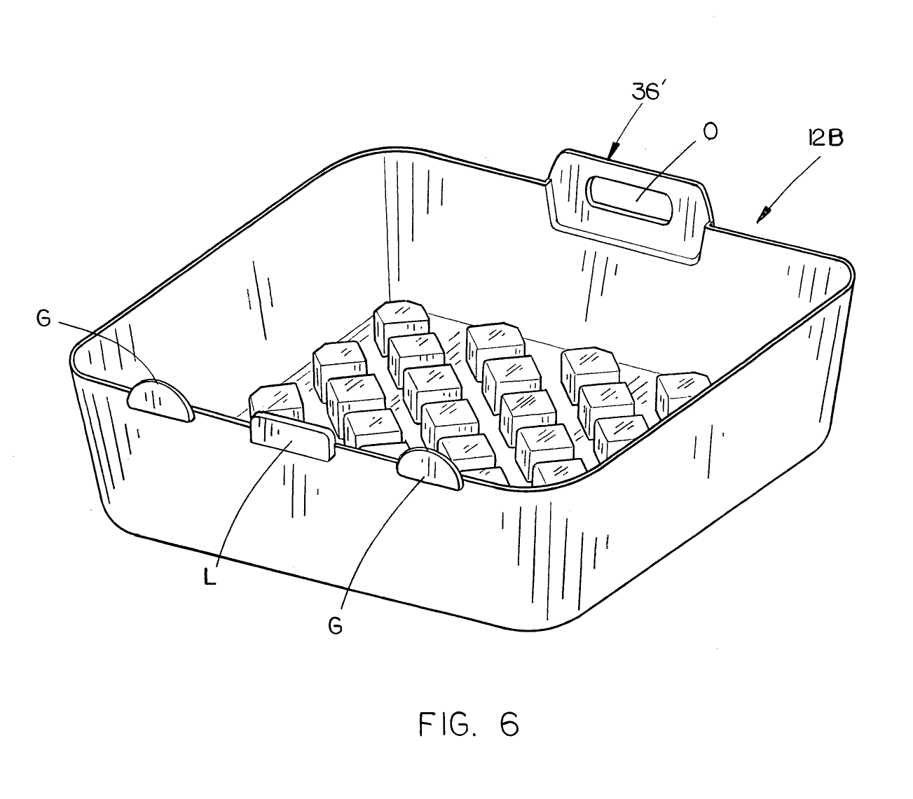

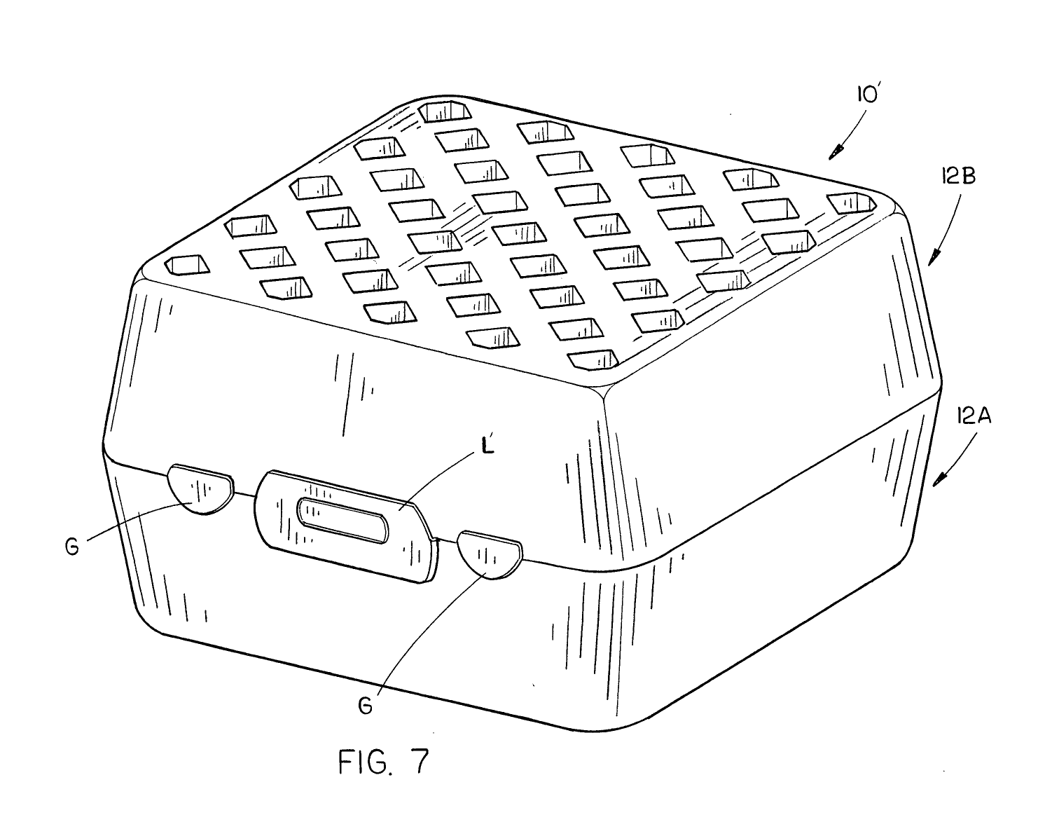

FIGS. 5-8 illustrate a second embodiment of the invention. In FIGS. 5-8, the numeral 10′ refers to the second embodiment which includes tray members 12A and 12B which are essentially identical to tray members 12 and 12′ except that the side and end walls thereof extend upwardly and outwardly from the bottom wall to enable the tray members 12A and 12B to be nested together for storage and transport. The other difference between the embodiment of FIGS. 5-8 and that of FIGS. 1-4 is that the upstanding latch member 36′ does not have an inwardly protruding projection but has an elongated opening O formed therein and that the second latch member L includes an outwardly projecting member L′ which is adapted to be received in the opening O of the latch member 36′.

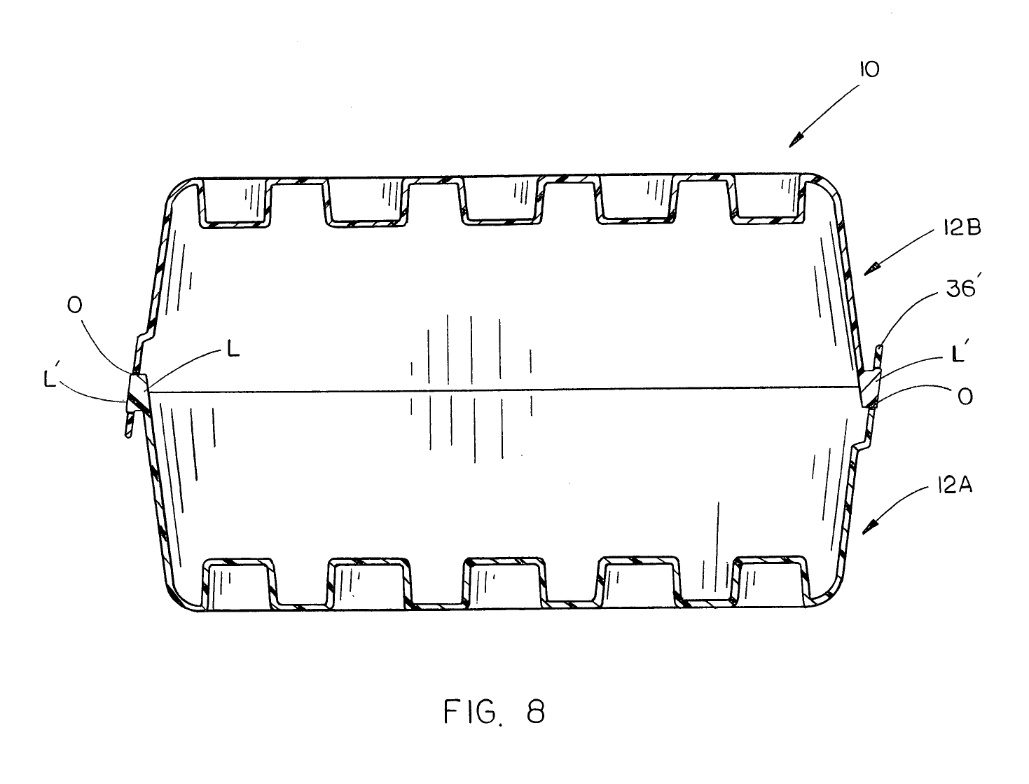

As seen in FIG. 8, when tray member 12B is placed upon tray member 12A, the outwardly projecting member L′ of tray member 12B is received in the opening O of tray member 12A and the outwardly projecting portion L1 of tray member 12A is received in the opening O of tray member 12B. As also seen in FIG. 5, each of the tray members has a pair of spaced-apart guide members G extending upwardly from the tray member on opposite sides of the latch L.

The tray members 12A and 12B perform the same functions as tray members 12 and 12′ except that the tray members 12A and 12B may be nested and the means for connecting the tray members 12A and 12B is somewhat different than the way tray members 12 and 12′ are connected together.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A device for cleaning and drying the paw of a pet such as a dog or the like, comprising:
a first tray member including a bottom wall having first and second end walls and first and second side walls extending upwardly therefrom which have upper edges and inner and outer sides;
a first latch member extending upwardly from said first end wall of said first tray member;
a second latch member positioned on said outer side of said second end wall of said first tray member;
a second tray member including a bottom wall having first and second end walls and first and second side walls extending upwardly therefrom which have upper edges and inner and outer sides;
a first latch member extending upwardly from said first end wall of said second tray member;
a second latch member positioned on said outer side of said second end wall of said second tray member;
said first and second tray members being substantially identical so as to be interchangeable with one another;
said first and second tray members being normally disconnected from one another so that said first tray member may have water placed therein for cleaning a paw of the pet when the paw is placed therein and so that the clean paw, after removal from said first tray member, may be placed in said second tray member for drying;
said second tray being positionable on said first tray member, when inverted and rotated 180°, so that said first latch member of said second tray member may be latched to said second latch member of said first tray member and so that said first latch member of said first tray member may be latched to said second latch member of said second tray member to secure said first and second tray members together in a closed position.

2. The device of claim 1 wherein said bottom walls of said first and second tray members have a plurality of spaced-apart projections extending upwardly therefrom.

3. The device of claim 2 wherein each of said projections are hollow with a closed upper end.

4. The device of claim 1 further including a drying member placed in said second tray member.

5. The device of claim 1 wherein said drying member comprises a towel.

6. The device of claim 1 wherein said first latch members are comprised of a flexible material so that the upper ends of said first latch members may be deflected laterally.

7. The device of claim 1 wherein each of said first latch members have an inner surface and wherein a latch bar is provided on said inner surface thereof for selective engagement with said second latch members of the associate tray member.

8. The device of claim 1 wherein said first and second tray members, when in their closed position, from a spill-resistant container.

9. The device of claim 1 wherein said first and second tray members are comprised of a plastic material.

10. The device of claim 1 wherein said projections are generally square-shaped.

11. A device for cleaning and drying a paw of a pet such as a dog or the like, comprising:
a first tray member including a bottom wall having first and second end walls and first and second side walls extending upwardly therefrom which have upper edges and inner and outer sides;
a second tray member including a bottom wall having first and second end walls and first and second side walls extending upwardly therefrom which have upper edges and inner and outer sides;
said first and second tray members being substantially identical so as to be interchangeable with one another;
said first and second tray members being normally disconnected from one another so that said first tray member may have water placed therein for cleaning a paw of the pet when the paw is placed therein and so that the clean paw, after removal from said first tray member, may be placed in said second tray member for drying;
said second tray member being selectively positionable on said first tray member for transport or storage.

12. The device of claim 11 wherein said bottom walls of said first and second tray members have a plurality of spaced-apart projections extending upwardly therefrom.

13. The device of claim 12 wherein said projections are generally square-shaped.

14. The device of claim 11 wherein said first and second end walls of said first and second side walls of each of said first and second tray members extend upwardly and outwardly from said bottom wall thereof.

15. The device of claim 11 wherein a first latch member extends upwardly from said first end wall of each of said first and second tray members, each of said first latch members having a latch opening formed therein, a second latch member extending upwardly from said second end wall of each of said first and second tray members, each of said second latch members having an outwardly extending latching projection, said second tray being positionable on said first tray member, when inverted and rotated 180°, so that said outwardly extending latching projection of said second latch member of said second tray member may be received by the latch opening of said first latch member of said first tray member and so that said outwardly extending latching projection of said second latch member of said first tray member may be received by the latch opening in said first latch member of said second tray member to secure said first and second tray members in a closed position.

16. The device of claim 11 wherein said first and second tray members are identical so as to be interchangeable.
